(19) United States
(12) Patent Application Publication
(10) Pub. No.: US 2014/0351515 A1
(43) Pub. Date: Nov. 27, 2014

(54) PROVIDING DATA ATTRIBUTES TO A STORAGE MANAGER TO USE TO SELECT A STORAGE TIER TO USE FOR A DATA SET MANAGEMENT OPERATION

(71) Applicant: International Business Machines Corporation, Armonk, NY (US)

(72) Inventors: Lawrence Y. Chiu, Saratoga, CA (US); Sangeetha Seshadri, San Jose, CA (US); Peter G. Sutton, Poughkeepsie, NY (US); Glenn R. Wilcock, Tucson, AZ (US); Harry M. Yudenfriend, Poughkeepsie, NY (US)

(73) Assignee: International Business Machines Corporation, Armonk, NY (US)

(21) Appl. No.: 13/899,371

(22) Filed: May 21, 2013

(51) Int. Cl. G06F 12/08

(52) U.S. Cl. CPC G06F 12/08
USPC 711/117

(57) ABSTRACT

Provided are a computer program product, system, and method for an application to provide data attributes to a storage manager to use to select a storage tier to use for a data set management operation. Each storage tier has storage devices with different storage attributes. The storage manager receives information on data attributes for one of the data sets for which a data set management operation is to be performed for an application, wherein the data attributes are based on the application intended usage of the data set and receives a data set management command to perform the data set management operation. The storage manager selects one of the storage tiers having storage attributes that map to the data attributes and performs the data set management operation with respect to the selected storage tier.

### BACKGROUND OF THE INVENTION

1. Field of the Invention

The present invention relates to a computer program product, system, and method for providing data attributes to a storage manager to use to select a storage tier to use for a data set management operation.

2. Description of the Related Art

A Multi-tiered Storage System is a strategic networked storage method where data is stored on various types of storage devices primarily based on criteria of the access, frequency of use, security and data recovery requirements. For space and performance optimization, the data is transferred between high-cost and low-cost storage media. Such systems exist because high-speed storage devices, such as Solid State devices (SSD), Hard Disk Drive Arrays, etc., are more expensive (per byte stored) than the slower storage devices, such as optical discs and magnetic tape drives. While it would be ideal to have all data available on high-speed devices all the time, this is prohibitively expensive for many organizations. Instead, tiered systems store the bulk of the enterprise's data on slower devices, and then migrate more frequently accessed data to faster media when needed. The advantage is that the total amount of stored data can be much larger than the capacity of the active storage media available. In effect, tiered systems turn the fast storage devices into caches for the slower mass storage devices.

Storage tiering is the placement of data on different devices in the multi-tiered storage based on the type of usage, performance and capacity requirements of the data and the characteristics of the devices. Storage tiering is often a manual process where administrators manually assign data to different locations within the multi-tiered storage system.

Automated storage tiering programs automatically manage data placement by observing the characteristics of data in the multi-tiered storage and automatically moving the data among the different tiers of storage. Automated storage tiering decisions are based on observation of workloads or pre-set administrator policies which statically partition resources. To determine where to store data in a multi-tier storage system, a storage manager program will analyze data access patterns, workloads on the storage devices, and usage of the devices and determine the tiers and devices within tiers on which to locate data.

### SUMMARY

Provided are a computer program product, system, and method for an application to provide data attributes to a storage manager to use to select a storage tier to use for a data set management operation. Each storage tier has storage devices with different storage attributes. The storage manager receives information on data attributes for one of the data sets for which a data set management operation is to be performed for an application, wherein the data attributes are based on the application intended usage of the data set and receives a data set management command to perform the data set management operation. The storage manager selects one of the storage tiers having storage attributes that map to the data attributes and performs the data set management operation with respect to the selected storage tier.

### BRIEF DESCRIPTION OF THE DRAWINGS

FIG. 1 illustrates an embodiment of a storage environment.

FIG. 2 illustrates an embodiment of storage tier information.

FIG. 3 illustrates an embodiment of data set information.

FIG. 4 illustrates an embodiment of a storage management command.

FIG. 5 illustrates an embodiment of operations performed by an application to initiate a data set management operation.

FIG. 6 illustrates an embodiment of operations performed by a storage manager to process a data set management command.

FIG. 7 illustrates an embodiment of operations performed by an application and storage manager to process an allocate storage space data set management operation.

FIG. 8 illustrates an embodiment of operations performed by an application and storage manager to process a close data set management operation.

FIG. 9 illustrates an embodiment of operations performed by an application and storage manager to process an open data set management operation.

FIG. 10 illustrates an embodiment of operations performed by an application and storage manager to process a delete data set management operation.

FIG. 11 illustrates an embodiment of operations performed by an application and storage manager to process a policy data set management operation.

FIG. 12 illustrates an embodiment of operations performed by an application and storage manager to process a data transfer data set management operation.

FIG. 13 illustrates an embodiment of operations performed by an application and storage manager to process a reorganize data set management operation.

FIG. 14 illustrates an embodiment of a computer architecture used with described embodiments.

### DETAILED DESCRIPTION

Described embodiments provide techniques for an application to provide data attributes concerning an application's intended usage of a data set with a data set management command for the data set. The storage manager may use the application data attributes to select a storage tier based on the application's intended use of the data set for a data set management operation.

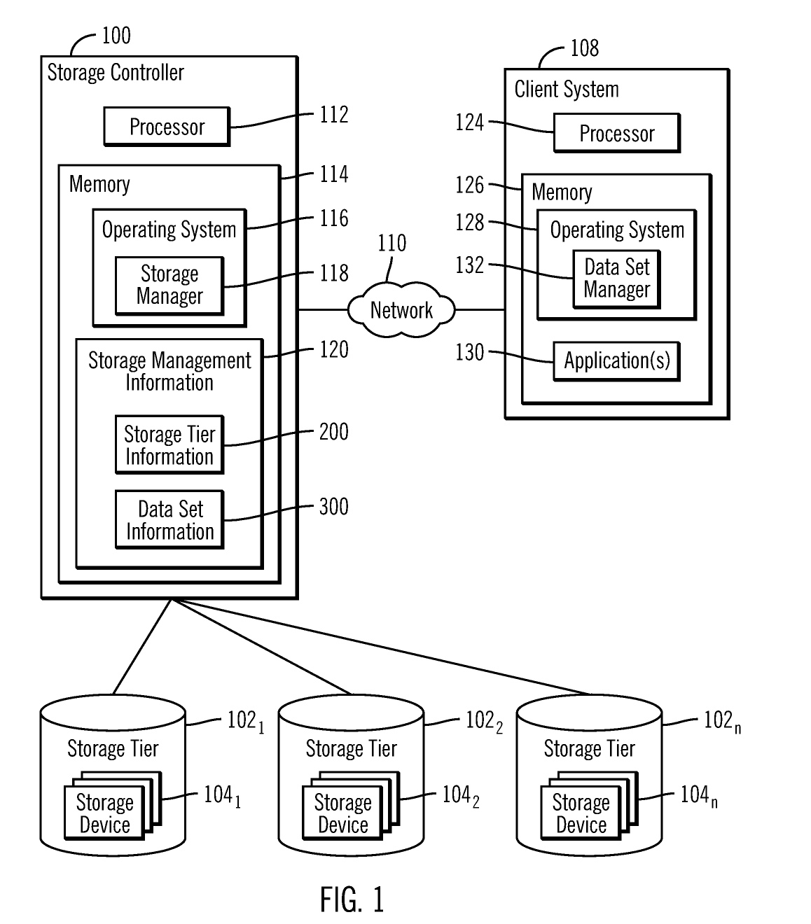

FIG. 1 illustrates a storage environment having a storage controller 100 managing the storage of data sets on multiple storage tiers 102₁, 102₂ . . . 102ₙ, each tier having a plurality of storage devices 104₁, 104₂ . . . 104ₙ. Each storage tier 102₁, 102₂ . . . 102ₙ may have storage devices 104₁, 104₂ . . . 104ₙ with storage attributes that differ from the storage attributes of other tiers, where the storage attributes may indicate a quality of service, access speed, longevity of duration of storage, etc. A client system 108 communicates with the storage controller 100 over a network 110. A data set may comprise any grouping of data, such as a file, extents that form grouping of tracks and data storage units, that is stored in the storage devices 104₁, 104₂ . . . 104ₙ.

The storage controller 100 includes a processor 112, comprising one or more processor devices and a memory 114 in which an operating system 116 is loaded to be executed by the processor 112. The operating system 116 includes a storage manager 118 to manage the storage of data in the storage tiers 102₁, 102₂ . . . 102ₙ and migrate data between the storage tiers 102₁, 102₂ . . . 102ₙ based on data management criteria, such as used in a multi-tiered storage system or hierarchical storage management system (HSM). The storage devices 104₁, 104₂, . . . 104ₙ may be grouped in multiple tiers based on their performance with respect to data access, where each tier has a class of slower access devices than a previous tier in the hierarchy of tiers. The arrangement of storage tiers 102₁, 102₂ . . . 102ₙ may be based on characteristics such as speed of their Input/Output (I/O) access profile, redundancy, etc. In one embodiment, the first tier may comprise memory, second tier solid state storage devices (SSD), third tier hard disk drive (HDDs), and fourth tier an archival storage medium, such as tape, optical disk or slower access hard disk drives. The storage manager 118 may manage the transfer of data and objects between tiers based upon characteristics of the data changing, such as frequency of access, size, etc.

The storage manager 118 maintains storage management information 120 to manage the storage of data sets in the storage tier, such as storage tier information 200 having information on the storage tiers 102₁, 102₂ . . . 102ₙ and data set information 300 having information on the data sets stored in the storage tiers 102₁, 102₂ . . . 102ₙ.

The client system 108 includes a processor 124 and a memory 126 storing programs executed by the processor 124, including an operating system 128 and applications 130. The application 130 may generate data set management operations to send to the storage controller 100. Further a data set manager 132 at the client 108 may also generate data set management operations for the storage controller 100 to manage the storage of application data sets in the storage tiers 102₁, 102₂ . . . 102ₙ.

In the embodiment of FIG. 1, the application 130 executes in a client system 108 that communicates with the storage controller 100 over the network 110. In a further embodiment, the applications 130 may execute in the storage controller 100 and send data set management commands to the storage manager 118 within the memory 114 of the storage controller 100. Yet further, the application 130 may execute on a blade within the same unit as the storage controller 100 or in a virtual virtualization layer executing on the same hardware platform or host in which a storage controller 100 virtualization layer is implemented.

The network 110 may comprise a Storage Area Network (SAN), Wide Area Network (WAN), Local Area Network (LAN), the Internet, and Intranet, a wireless network, wired network, etc.

The storage devices 104₁, 104₂ . . . 104ₙ may comprise different types or classes of storage devices, such as a solid state storage device (SSD) comprised of solid state electronics, such as a EEPROM (Electrically Erasable Programmable Read-Only Memory), flash memory, flash disk, Random Access Memory (RAM) drive, storage-class memory (SCM), etc., magnetic storage disk, optical disk, tape, etc. The storage devices 104₁, 104₂ . . . 104n may further be configured into an array of devices, such as Just a Bunch of Disks (JBOD), Direct Access Storage Device (DASD), Redundant Array of Independent Disks (RAID) array, virtualization device, etc. Further, the storage devices 104₁, 104₂ . . . 104n may comprise heterogeneous storage devices from different vendors.

The memories 114 and 126 may comprise one or more volatile or non-volatile memory devices. The storage manager 118, application 130 and data set manager 132 may be implemented as a program that is part of the operating systems 116, 128. Alternatively, the storage manager 118, application 130 and data set manager 132 may be implemented as application code external to the operating systems 116, 128 or may be implemented with hardware logic, such as an Application Specific Integrated Circuit (ASIC), or as a programmable processor executing code in a computer readable storage medium.

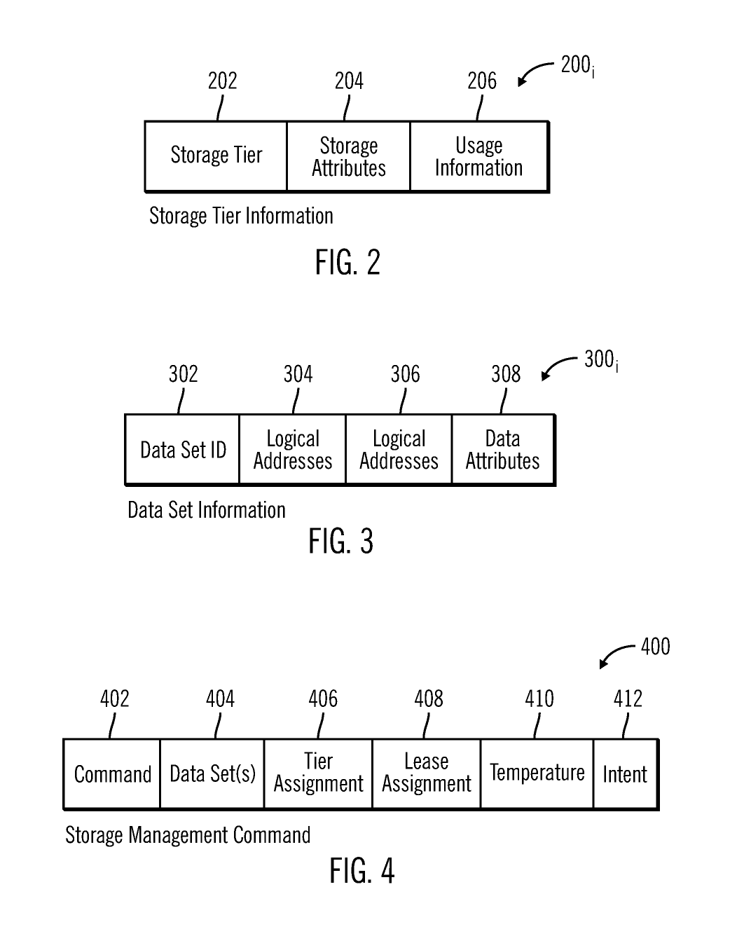

FIG. 2 illustrates an instance 200, of the storage tier information 200 maintained for each of the managed storage tiers 102₁, 102₂ . . . 102ₙ, including a storage tier identifier 202; storage attributes 204 of the tier 202, such as the access characteristics, quality of service level, speed, durability, cost, etc.; and usage information 206 having information on the current usage level of the storage tier 202, such as number and characteristics of application accesses, available storage space, etc.

FIG. 3 illustrates an instance 300, of the data set information 300 maintained for each data set stored in the storage tiers 102₁, 102₂ . . . 102ₙ, including a data set identifier (ID) 302; the logical addresses 304 of the data set 302; the physical addresses 306 in one of the storage tiers 102₁, 102₂ . . . 102ₙ at which the data set 302 is stored; and data attributes 308 of the data set, such as access characteristics, details on the application 130 that owns or accesses the data set, type of data (e.g., critical, non-critical, user data, backup data, etc.).

FIG. 4 illustrates an embodiment of a storage management command 400 the application 130 and the data set manager 132 may send to the storage controller 100 to perform a data set management operation with respect to a data set stored in the storage tiers 102₁, 102₂ . . . 102ₙ. The storage management command 400 includes a command 402 or operand identifying the command, e.g., allocate, open, close, delete, copy, move, reorganize, defragment, etc.; one or more data sets 40 to which the command 402 applies; and optionally includes various data attributes 406, 408, 410, and 412 that provide hints or instructions that the storage manager 118 uses to select one of the storage tiers 102₁, 102₂ . . . 102ₙ to use for the data set management operation. The data attributes may include an indication of a tier assignment 406 comprising the specific storage tier 102₁, 102₂ . . . 102ₙ to use, tiers not to use, a range of tiers to use, etc.; a lease assignment 408 indicating a time frame during which the provided data attributes are applicable for use with the storage management command 402; a temperature 410 indicating a level of expected access of the data set by the application 130, such as hot, warm or cold, indicating the data set will be frequently accessed, moderately accessed or infrequently accessed; and an intent 412 on the type of access expected for the data set 404, such as write only, read/write, read only, allocation, etc. The data attributes provided may indicate other information or expected application usage.

The intent 412 may further indicate whether the provided data attributes comprise a hint or instruction. An instruction may specify that the storage manager 118 must use the provided data attributes to select the storage tier 102₁, 102₂ . . . 102ₙ, even if they conflict with other factors the storage manager 118 considers when selecting a storage tier 102₁, 102₂ . . . 102ₙ. The instruction indicator may further instruct the storage manager 118 to retain the data set in the specified tier for the entire duration or time frame specified by the instruction. If the intent 412 indicates that the data attributes comprise a hint, then the storage manager 118 may consider the provided data attributes with additional factors the storage manager 118 considers, such as storage usage information 206. If the provided data attributes comprise a hint that are considered with other factors, then a storage tier may be selected that is different from the storage tier that would be selected if only the provided data attributes were considered. Thus, in the case of a hint, the provided data attributes in the command 400 may be offset by other factors the storage manager 118 weights greater than the provided data attributes 406, 408, 410, 412.

In one implementation, the data attributes 406, 408, 410, and 412 may be included in the command 400. In further implementations, the data attributes may be sent in a packet separate from the command although associated with the data set management command.

The data attributes 406, 408, 410, and 412 may be provided by the application 130 or some other higher layer at the storage controller 100 or client 108 to provide hints to improve the storage controller 100 placement decisions and facilitate support for policy based resource management and performance levels. The hints or data attributes provided with the command 400 may be more fine grained than factors regularly used by the storage manager 118, may influence placement of a data set in real time during a data set management operation, may be tied to the specific application 130 future intended usage or system event unknown to the storage controller 100 layer, and allow different virtualization layers to execute and interpret the data attribute hint according to specific internal architecture and constraints.

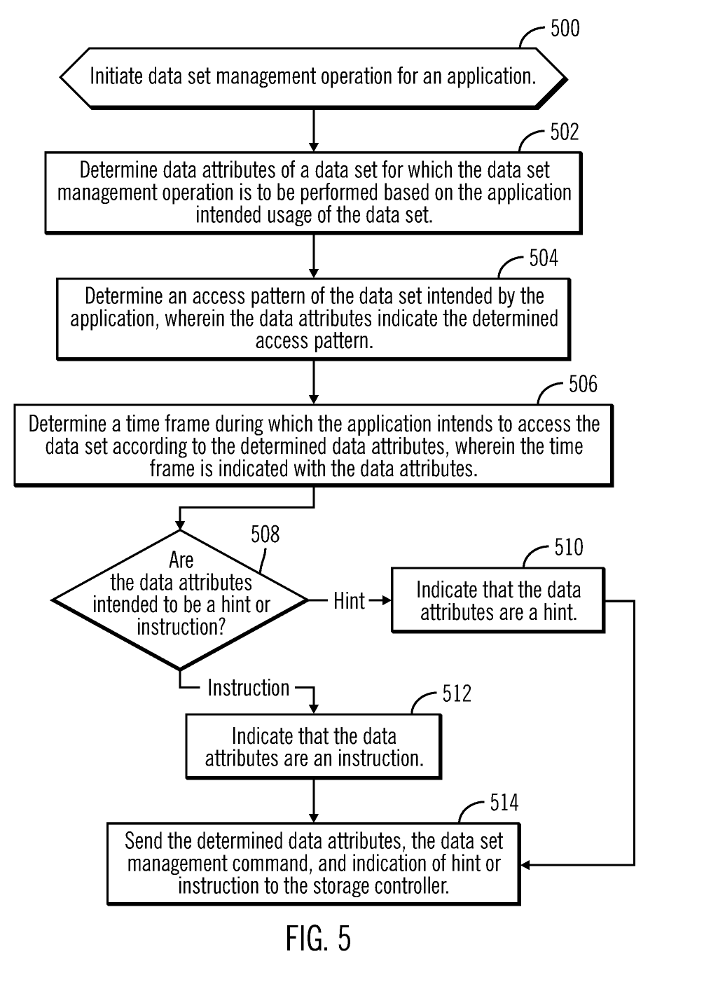

FIG. 5 illustrates an embodiment of operations performed by the application 130 or data set manager 132 to perform a data set management operation for an application. Upon initiating (at block 150) a data set management operation, the application 130 determines (at block 502) data attributes of a data set for which the data set management operation is to be performed based on the application intended usage of the data set. Operations 504-512 provide embodiments of operations to determine data attributes. As part of determining the data attributes, the application 130 may determine (at block 504) an access pattern of the data set intended by the application 130, a time frame 406 (at block 506) during which the application 130 intends to access the data set according to the determined data attributes, as well as other attributes, such as a storage tier to use, etc. The application 130 may determine (at block 508) whether the determined data attributes are to be indicated (at block 512) as an instruction, where they are assured to control the selection of the storage tier to 102₁, 102₂ . . . 102ₙ at the storage controller 100, or a hint (at block 510) where they are considered with other factors. The application 130 may make this determination of whether the attributes are an instruction or hint based on the importance or critical nature of the data set and need to be stored in a manner consistent with the data attributes or whether the application 130 determined data attributes may be considered with storage tier information 200. The application 130 sends (at block 514) the determined data attributes 404, 406, 408, the data set management command 400, and indication of hint or instruction 410 to the storage controller 100

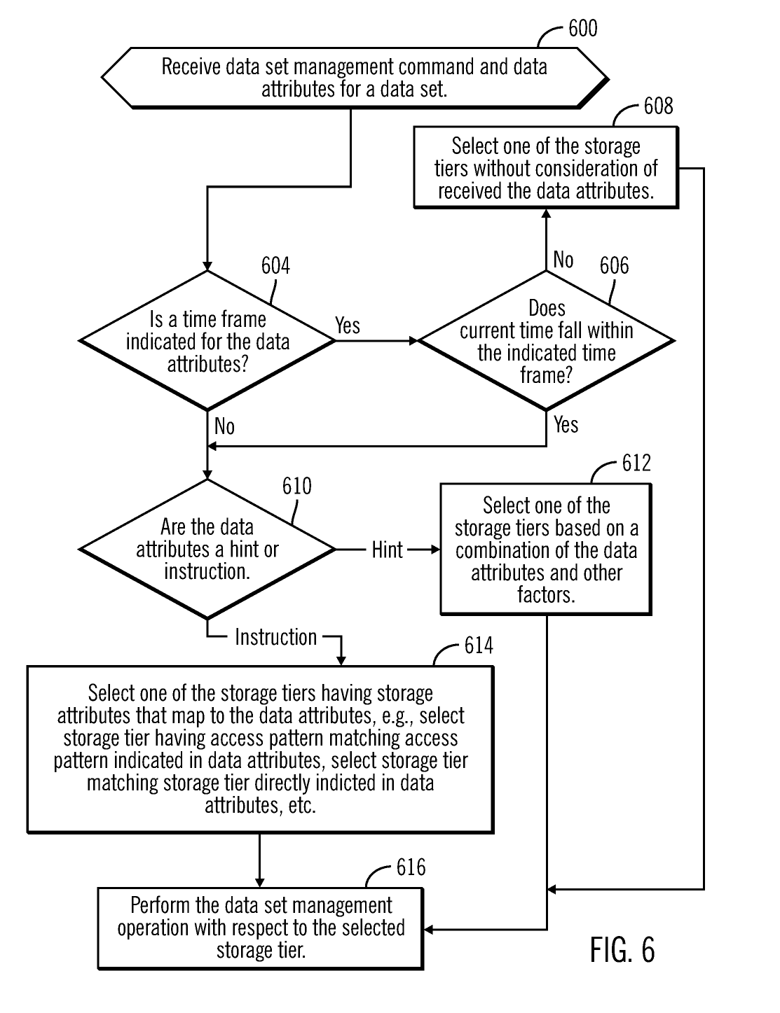

FIG. 6 illustrates an embodiment of operations performed by the storage manager 118 of the storage controller 100 to process a data set management command 400 from the application 130 or data set manager 132 at the client 108. Control begins with the storage manager 118 receiving (at block 600) the data set management command 400 and data attributes for the data set. If (at block 604) a time frame 406 is indicated for the data attributes and if (at block 606) a current time at the storage controller 100 does not fall within the indicated time frame 506, for which a data set management operation is to be performed for an application, then selection is made (at block 608) of the storage tier 102₁, 102₂ . . . 102ₙ without consideration of the received data attributes, e.g., 406-412, such as based on data set information 300 and storage tier information 200. If (from the yes branch of block 606) the current time falls within the indicated time frame or if (from the no branch of block 604) or no time frame is indicated, then the storage manager 118 determines (at block 610) whether the data attributes are a hint or instruction.

In a further implementation, if the hint/instruction arrives at the storage controller 100 prior to the specified time frame, then the hint/instruction may be saved and re-processed to later be used to select the storage tier. In further implementations, the storage manager 100 may proceed with processing the command and data attributes ahead of the time specified in the time frame in order to meet the time deadlines specified in the lease assignment 408.

If (at block 610) they are a hint, then the storage manager 118 selects (at block 612) one of the storage tiers 102₁, 102₂ . . . 102ₙ based on a combination of the received data attributes and the other factors considered by the storage controller 100, such as storage tier information 200 and data set information 300. Selection based on the received application data attributes and other factors, such as information at the storage controller 108, may result in a selection of a storage tier 102₁, 102₂ . . . 102ₙ not suggested by the application sent data attributes alone. The storage manager 118 may assign different or the same weights to the data attributes and other factors, e.g., storage information 200 and 300, to determine a mapping of the weighted information to storage attributes 204 to determine a storage tier 102₁, 102₂ . . . 102ₙ. Further, the storage manager 100 may update internal metadata, such as the data attributes 308 of the data set information 300 the storage manager 100 maintains to reflect information related to the data set management operation performed in response to the data set command.

If (at block 610) the data attributes are an instruction, then the storage manager 118 selects (at block 614) one of the storage tiers 102₁, 102₂ . . . 102ₙ having storage attributes 204 that map to the data attributes, e.g., select storage tier 102₁, 102₂ . . . 102ₙ having an access pattern matching access pattern indicated in data attributes, a storage tier matching storage tier directly indicted in data attributes, etc. Upon selecting the storage tier at one of blocks 608, 612, and 614, the storage manager 118 performs (at block 616) the data set management operation with respect to the selected storage tier 102₁, 102₂ . . . 102ₙ.

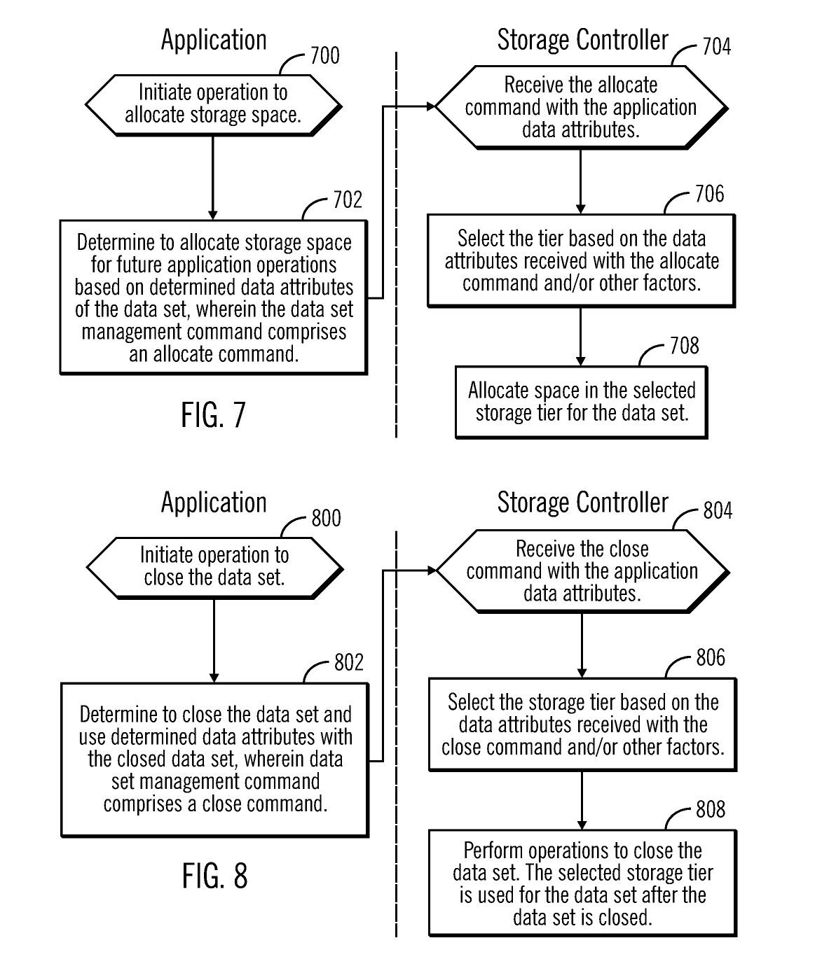

FIGS. 7-13 illustrate operations performed by the application 130 and the storage controller 100 for specific different types of data set management operations, which figures provide the data set management specific operations.

FIG. 7 illustrates an embodiment of operations performed by the application 130 (or data set manager 132) and the storage manager 118 of the storage controller 100 for an allocation data set management operation. When the application 130 initiates (at block 700) an operation to allocate storage space for a data set in one of the storage tiers 102₁, 102₂ . . . 102ₙ, the application 130 determines (at block 702) to allocate storage space for future application 130 operations based on determined data attributes for the data set. The data set management command 400 comprises an allocate command.

Upon the storage manager 118 receiving (at block 704) the allocate command 400 with the application data attributes, the storage manager 118 selects (at block 706) the storage tier based on the data attributes, such as by performing the operations described with respect to FIG. 6 to select a storage tier based on the received data attributes and/or other factors. The storage manager 118 then allocates (at block 708) space in the selected tier for the data set that the application 130 intends to use.

FIG. 8 illustrates an embodiment of operations performed by the application 130 (or data set manager 132) and the storage manager 118 of the storage controller 100 for a close data set management operation. When the application 130 initiates (at block 800) an operation to close the data set, the application 130 determines (at block 802) to close the data set and use determined data attributes with the closed data set. In such case, the data set management command 400 comprises a close command.

Upon the storage manager 118 receiving (at block 804) the close command 400 with the application data attributes, the storage manager 118 selects (at block 806) the tier based on the data attributes, such as by performing the operations described with respect to FIG. 6 to select a storage tier 102₁, 102₂ . . . 102ₙ based on the received data attributes and/or other factors. The storage manager 118 then performs (at block 808) the necessary operations to close the data set as requested by the application 130. The selected storage tier 102₁, 102₂ . . . 102ₙ is used for the data set after being closed. For instance, the selected storage tier 102₁, 102₂ . . . 102ₙ may be used to store the data set after being closed or to determine where the data set will be placed once the data set is re-opened.

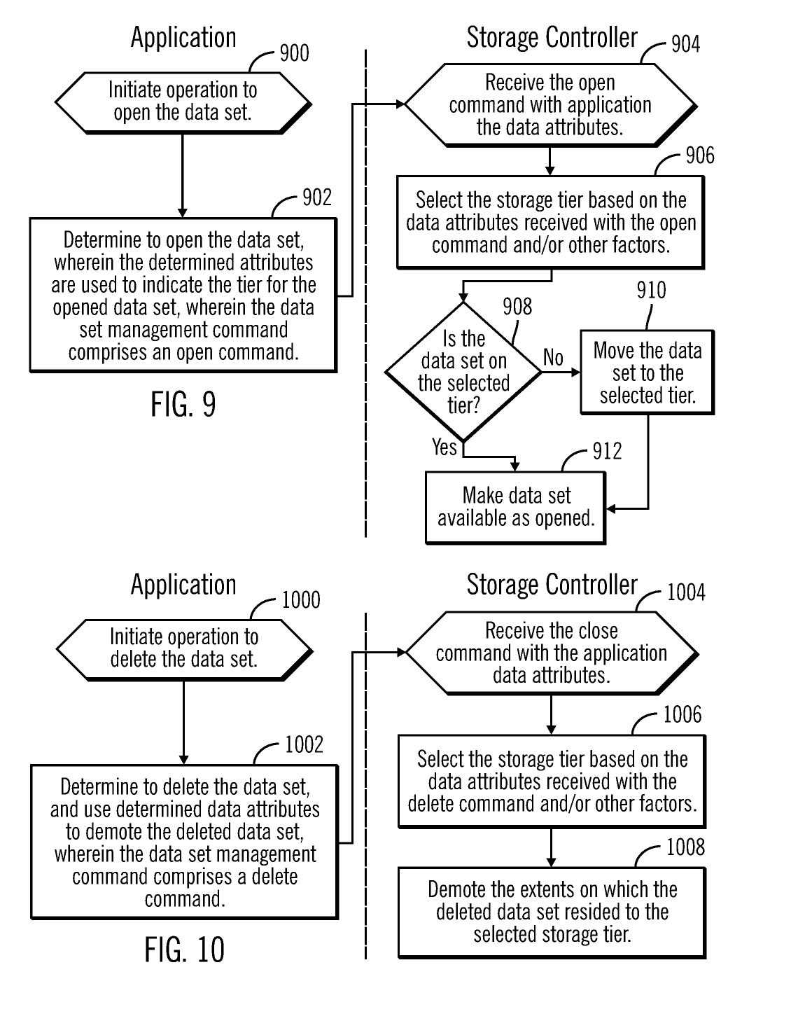

FIG. 9 illustrates an embodiment of operations performed by the application 130 (or data set manager 132) and the storage manager 118 of the storage controller 100 for an open data set management operation. When the application 130 initiates (at block 900) an operation to open the data set, the application 130 determines (at block 902) to open the data set, wherein the determined attributes are used to indicate the tier for the opened data set. In such case, the data set management command 400 comprises an open command.

Upon the storage manager 118 receiving (at block 904) the open command 400 with the application data attributes, the storage manager 118 selects (at block 906) the storage tier 102₁, 102₂ . . . 102ₙ based on the data attributes and/or other factors, such as by performing the operations described with respect to FIG. 6 to select a storage tier 102₁, 102₂ . . . 102ₙ. If (at block 908) the data set is not already transferred onto the selected storage tier 102₁, 102₂ . . . 102ₙ, then the storage manager 118 moves (at block 910) the data set to the selected storage tier 102₁, 102₂ . . . 102ₙ. The data set located on the selected storage tier 102₁, 102₂ . . . 102ₙ is then available as opened (at block 912).

FIG. 10 illustrates an embodiment of operations performed by the application 130 (or data set manager 132) and the storage manager 118 of the storage controller 100 to delete a data set for a delete management set operation. When the application 130 initiates (at block 1000) an operation to delete the data set, the application 130 determines (at block 1002) to delete the data set and use the determined data attributes with the deleted data set. In this case, the data set management command 400 comprises a delete command.

Upon the storage manager 118 receiving (at block 1004) the delete command 400 with the application data attributes, the storage manager 118 selects (at block 1006) the storage tier based on the data attributes received with the delete command and/or other factors, such as by performing the operations described with respect to FIG. 6. The storage manager 118 then demotes (at block 1008) the physical extents on which the deleted data set resided set to the selected storage tier 102₁, 102₂ . . . 102ₙ. For instance, the extents on which the deleted data set were stored may be indicated on a demote list and then later demoted to that selected storage tier.

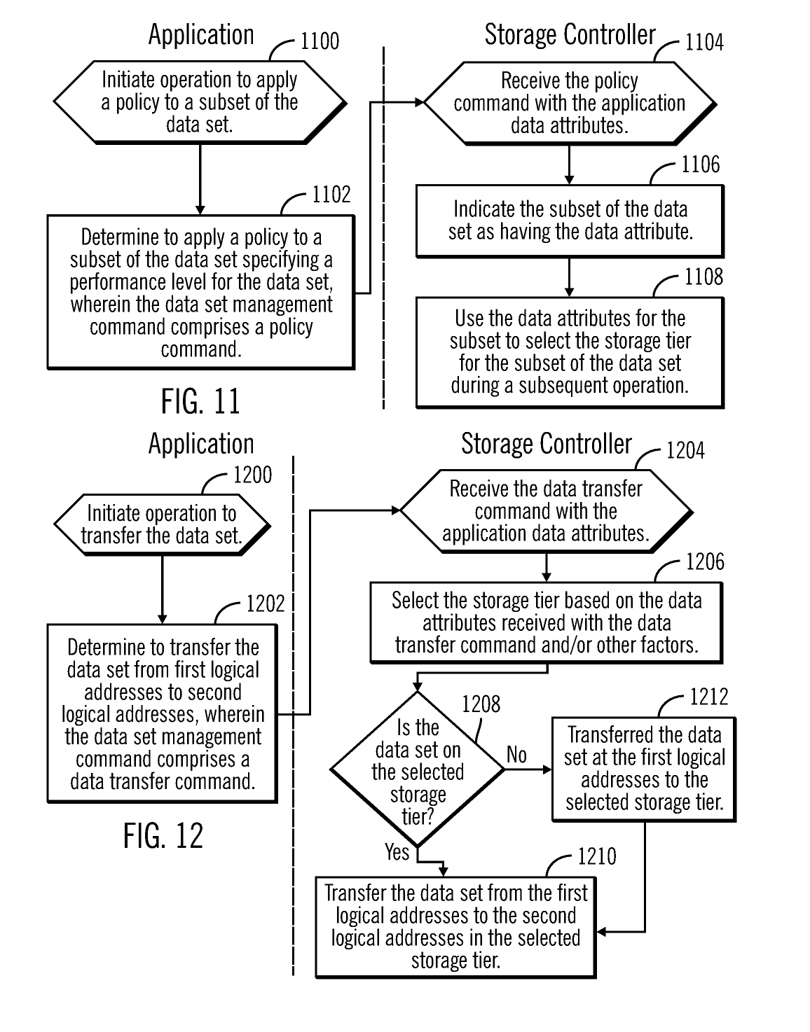

FIG. 11 illustrates an embodiment of operations performed by the application 130 (or data set manager 132) and the storage manager 118 of the storage controller 100 to apply a policy to a subset of the data set for a policy management set operation. The subset of the data set may comprise the entire data set or any portion or portions of the data set. When the application 130 initiates (at block 1100) an operation to specify a policy for the data set, the application 130 determines (at block 1102) to apply a policy to a subset of the data set specifying a performance level for the data set. In this case, the data set management command 400

comprises a policy command.

Upon the storage manager 118 receiving (at block 1104) the policy command 400 with the application data attributes for the subset of the data set, the storage manager 118 indicates (at block 1106) the subset of the data set as having the data attributes. Such as in the data attributes 308 of the data set information 300 for the effected subset. The storage manager 116 uses (at block 1108) the data attributes for the subset to select the storage tier 102₁, 102₂ . . . 102ₙ to use during a subsequent operations, such as a data set management operation.

FIG. 12 illustrates an embodiment of operations performed by the application 130 (or data set manager 132) and the storage manager 118 of the storage controller 100 for a data transfer data set management operation, such as a copy or move operation. When the application 130 initiates (at block 1200) an operation to perform a transfer operation on the data set, the application 130 determines (at block 1202) to transfer the data set from specified first logical addresses to second logical addresses. In such case, the data set management command 400 comprises a data transfer command, such as a copy or move command.

Upon the storage manager 118 receiving (at block 1204) the data transfer command 400 indicating a source and target logical addresses and with the application data attributes, the storage manager 118 selects (at block 1206) the storage tier 102₁, 102₂ . . . 102ₙ based on the data attributes and/or other factors, such as by performing the operations described with respect to FIG. 6 to select a storage tier 102₁, 102₂ . . . 102ₙ. If (at block 1208) the data set is not already located on the selected storage tier 102₁, 102₂ . . . 102ₙ, then the storage manager 118 transfers (at block 1210) the data set at the source logical addresses to the selected storage tier 102₁, 102₂ . . . 102ₙ. The data set located on the selected storage tier 102₁, 102₂ . . . 102ₙ (from the yes branch of block 1212 or 1214) is then transferred (at block 1216) from the source logical addresses to the second or target logical addresses in the selected storage tier 102₁, 102₂ . . . 102ₙ.

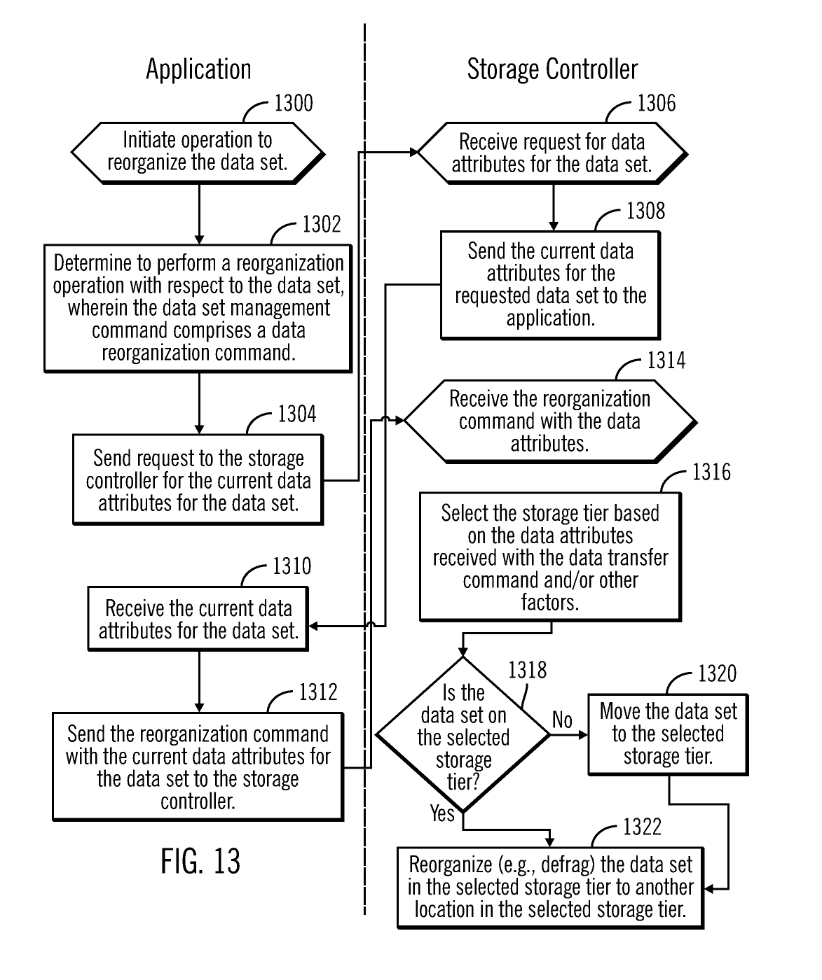

FIG. 13 illustrates an embodiment of operations performed by the application 130 (or data set manager 132) and the storage manager 118 of the storage controller 100 for a data reorganization data set management operation, such as a defragmentation or data or index reorganization operation. When the application 130 initiates (at block 1300) an operation to reorganize the data set, the application 130 determines (at block 1302) to perform a reorganization operation with respect to the data set. In such case, the data set management command 400 comprises a data reorganization command, such as a defragmentation command, data reorganization or index reorganization command. The application 130 sends (at block 1304) a request to the storage controller 100 for the current data attributes for the data set to reorganize.

Upon the storage manager 118 receiving (at block 1306) the request for the current data attributes, the storage manager 118 sends (at block 1308) the current data attributes 308 maintained by the storage manager 118 in data set information 300 (FIG. 3) for the requested data set to the application 130. Upon the application 130 receiving (at block 1310) the sent current data attributes for the data set, the application 130 sends (at block 1312) the reorganization command 400 with the current data attributes for the data set to the storage controller 100 to use for the reorganization.

In certain implementations, the application 130 queries the storage manager 100 for the current data set data attributes then passes back to the storage manager 130 for the data set management operation because the dataset reorganization operation may involve multiple storage controllers which do not have access to information at another storage controller.

Upon receiving the reorganization command with the data attributes (at block 1314), the storage manager 118 selects (at block 1316) the storage tier 102₁, 102₂ . . . 102ₙ based on the data attributes and/or other factors, such as by performing the operations described with respect to FIG. 6 to select a storage tier 102₁, 102₂ . . . 102ₙ. If (at block 1318) the data set is not already located on the selected storage tier 102₁, 102₂ . . . 102ₙ, then the storage manager 118 moves (at block 1320) the data set to the selected storage tier 102₁, 102₂ . . . 102ₙ. The data set located on the selected storage tier 102₁, 102₂ . . . 102ₙ (from the yes branch of block 1318 or 1320) is then reorganized (at block 1322) in the selected storage tier 102₁, 102₂ . . . 102ₙ.

Described embodiments provide techniques to allow an application to provide data attributes with a data set management operation so that the storage controller may select the appropriate storage tier 102₁, 102₂ . . . 102ₙ to use for the data set management operation, such as an OPEN, CLOSE, DELETE, POLICY, ALLOCATE, and REORGANIZE commands. In a hierarchical storage management system, the storage manager may use the data attributes to select a storage tier that satisfies the requirements of the data attributes for use with the data set management operation.

The described operations may be implemented as a method, apparatus or computer program product using standard programming and/or engineering techniques to produce software, firmware, hardware, or any combination thereof. Accordingly, aspects of the embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the embodiments may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The illustrated operations of the Figures show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

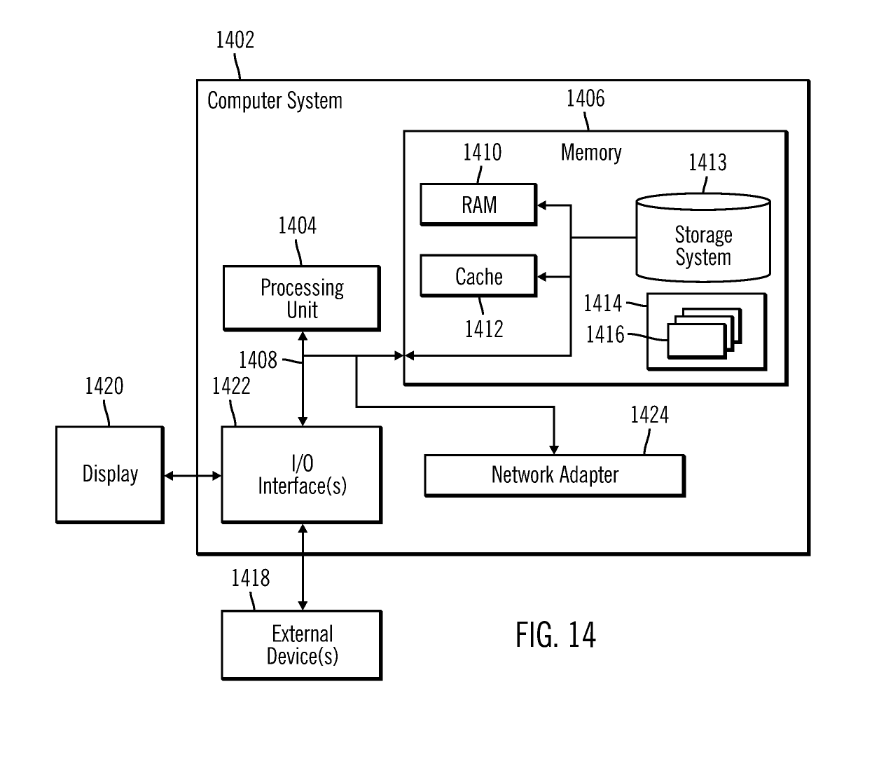

The storage controller 100 and client system 108, and components therein, may be implemented in one or more computer systems, such as the computer system 1402 shown in FIG. 14. If the components of the network computing environment of FIG. 1 are implemented in multiple systems, then the systems may communicate over the network 4. Computer system/server 1402 may be described in the general context of computer system executable instructions, such as program modules, being executed by a computer system. Generally, program modules may include routines, programs, objects, components, logic, data structures, and so on that perform particular resources or implement particular abstract data types. Computer system/server 1402 may be practiced in distributed cloud computing environments where resources are performed by remote processing devices that are linked through a communications network. In a distributed cloud computing environment, program modules may be located in both local and remote computer system storage media including memory storage devices.

As shown in FIG. 14, the computer system/server 1402 is shown in the form of a general-purpose computing device. The components of computer system/server 1402 may include, but are not limited to, one or more processors or processing units 1404, a system memory 1406, and a bus 1408 that couples various system components including system memory 1406 to processor 1404. Bus 1408 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 1402 typically includes a variety of computer system readable media. Such media may be any available media that is accessible by computer system/server 1402, and it includes both volatile and non-volatile media, removable and non-removable media.

System memory 1406 can include computer system readable media in the form of volatile memory, such as random access memory (RAM) 1410 and/or cache memory 1412. Computer system/server 1402 may further include other removable/non-removable, volatile/non-volatile computer system storage media. By way of example only, storage system 1413 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1408 by one or more data media interfaces. As will be further depicted and described below, memory 1406 may include at least one program product having a set (e.g., at least one) of program modules that are configured to carry out the functions of embodiments of the invention.

Program/utility 1414, having a set (at least one) of program modules 1416, may be stored in memory 1406 by way of example, and not limitation, as well as an operating system, one or more application programs, other program modules, and program data. Each of the operating system, one or more application programs, other program modules, and program data or some combination thereof, may include an implementation of a networking environment. The components of the computer 2 may be implemented as program modules 1416 which generally carry out the functions and/or methodologies of embodiments of the invention as described herein.

Computer system/server 1402 may also communicate with one or more external devices 1418 such as a keyboard, a pointing device, a display 1420, etc.; one or more devices that enable a user to interact with computer system/server 12; and/or any devices (e.g., network card, modem, etc.) that enable computer system/server 1402 to communicate with one or more other computing devices. Such communication can occur via Input/output (I/O) interfaces 1422. Still yet, computer system/server 1402 can communicate with one or more networks such as a local area network (LAN), a general wide area network (WAN), and/or a public network (e.g., the Internet) via network adapter 1424. As depicted, network adapter 1424 communicates with the other components of computer system/server 1402 via bus 1408. It should be understood that although not shown, other hardware and/or software components could be used in conjunction with computer system/server 1402. Examples, include, but are not limited to: microcode, device drivers, redundant processing units, external disk drive arrays, RAID systems, tape drives, and data archival storage systems, etc.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer program product for managing storage of data sets from an application in storage tiers of storage devices in a storage system, wherein each storage tier of storage devices has storage devices with different storage attributes, the computer program product comprising a computer readable storage medium having computer readable program code embodied therein that executes to perform operations, the operations comprising:
receiving information on data attributes for one of the data sets for which a data set management operation is to be performed for an application, wherein the data attributes are based on the application intended usage of the data set;
receiving a data set management command to perform the data set management operation;
selecting one of the storage tiers having storage attributes that map to the data attributes; and
performing the data set management operation with respect to the selected storage tier.

2. The computer program product of claim 1, wherein the data attributes indicate an access pattern of the data set, wherein the storage attributes of the storage tiers indicate different access patterns, and wherein the determination of the storage tier comprises determining the storage tier having storage attributes indicating an access pattern matching the access pattern of the data attributes of the data set.

3. The computer program product of claim 1, wherein the data attributes are sent with information indicating whether the data attributes comprise at least one of a hint and an instruction, wherein the selecting one of the storage tiers comprises:
selecting the storage tier based on the data attributes alone in response to the data attributes comprising the instruction;
selecting the storage tier based on the data attributes and factors unrelated to the data attributes in response to the data attributes comprising the hint, wherein when the data attributes comprise the hint, the selected storage tier is capable of comprising a storage tier that is different from the storage tier that would be selected if the data attributes alone were considered to select the storage tier.

4. The computer program product of claim 1, wherein the data attributes indicate a time frame during which the data attributes are applicable to the data set management operation, wherein the data attributes are only used to select the storage tier to use for the data set management operation during the time frame.

5. The computer program product of claim 1, wherein the data attributes indicate at least one of the storage tiers to use for the data set management operation, wherein selecting the storage tier comprises determining the storage tier indicated in the data attributes.

6. The computer program product of claim 1, wherein the data set management command comprises an allocate command to allocate storage in the selected storage tier for the data set, and wherein the data set management operation further comprises:
allocating space in the selected storage tier for the data set.

7. The computer program product of claim 1, wherein the data set management command comprises a close command to close the data set, and wherein the performing the data set management operation further comprises:
closing the data set, wherein the selected storage tier is used for the data set after the data set is closed.

8. The computer program product of claim 1, wherein the data set management command comprises an open command to open the data set, and wherein the performing the data set management operation further comprises:
transfer the data set to the selected storage tier if the data set to open is not already stored in the selected storage tier; and
opening the data set.

9. The computer program product of claim 1, where the data set management command comprises a delete command, and wherein the performing the data set management operation further comprises:
demoting extents including the deleted data set to the selected storage tier.

10. The computer program product of claim 1, wherein the data set command operation comprises a policy command for a subset of the data set, and wherein the performing the data set management operation further comprises:
indicating the subset of the data set as having the data attribute, wherein the data attributes for the subset of the data set are used to select the storage tier for the subset of the data set during a subsequent operation with respect to the data set.

11. The computer program product of claim 1, wherein the data set management command comprises a data transfer command to transfer the data set from first logical addresses to second logical addresses, and wherein the performing the data set management operation further comprises:
moving the data set at the first logical addresses to the selected storage tier if the first logical addresses are not currently located in the selected storage tier; and
after the first logical addresses are located in the selected storage tier, transferring the data set from the first logical addresses to the second logical addresses in the selected storage tier.

12. The computer program product of claim 1, wherein the data set management command comprises a data reorganization command, and wherein the performing the data set management operation further comprises:
sending to the application data set attributes for the data set in response to receiving a request from the application prior to receiving the data set management operation and the data attributes from the application;
wherein the performing the data reorganization operation comprises:
moving the data set to the selected storage tier if the data set is not current located in the selected storage tier; and
reorganizing the data set in the selected storage tier to another location in the selected storage tier.

13. A system for managing storage of data sets from an application in storage tiers of storage devices in a storage system, wherein each storage tier of storage devices has storage devices with different storage attributes, comprising:
a processor; and
a computer readable storage medium having code executed by the processor to perform operations, the operations comprising:
receiving information on data attributes for one of the data sets for which a data set management operation is to be performed for an application, wherein the data attributes are based on the application intended usage of the data set;
receiving a data set management command to perform the data set management operation;
selecting one of the storage tiers having storage attributes that map to the data attributes; and
performing the data set management operation with respect to the selected storage tier.

14. The system of claim 13, wherein the data attributes are sent with information indicating whether the data attributes comprise at least one of a hint and an instruction, wherein the selecting one of the storage tiers comprises:
selecting the storage tier based on the data attributes alone in response to the data attributes comprising the instruction;
selecting the storage tier based on the data attributes and factors unrelated to the data attributes in response to the data attributes comprising the hint, wherein when the data attributes comprise the hint, the selected storage tier is capable of comprising a storage tier that is different from the storage tier that would be selected if the data attributes alone were considered to select the storage tier.

15. The system of claim 13, wherein the data set management command comprises a data transfer command to transfer the data set from first logical addresses to second logical addresses, and wherein the performing the data set management operation further comprises:
moving the data set at the first logical addresses to the selected storage tier if the first logical addresses are not currently located in the selected storage tier; and
after the first logical addresses are located in the selected storage tier, transferring the data set from the first logical addresses to the second logical addresses in the selected storage tier.

16. The system of claim 13, wherein the data set management command comprises a data reorganization command, and wherein the performing the data set management operation further comprises:
sending to the application data set attributes for the data set in response to receiving a request from the application prior to receiving the data set management operation and the data attributes from the application;
wherein the performing the data reorganization operation comprises:
moving the data set to the selected storage tier if the data set is not current located in the selected storage tier; and
reorganizing the data set in the selected storage tier to another location in the selected storage tier.

17. A method for managing storage of data sets from an application in storage tiers of storage devices in a storage system, wherein each storage tier of storage devices has storage devices with different storage attributes, comprising:
receiving information on data attributes for a data set for which a data set management operation is to be performed for an application, wherein the data attributes are based on the application intended usage of the data set;
receiving a data set management command to perform the data set management operation;
selecting one of the storage tiers having storage attributes that map to the data attributes; and
performing the data set management operation with respect to the selected storage tier.

18. The method of claim 17, wherein the data attributes are sent with information indicating whether the data attributes comprise at least one of a hint and an instruction, wherein the selecting one of the storage tiers comprises:
selecting the storage tier based on the data attributes alone in response to the data attributes comprising the instruction;
selecting the storage tier based on the data attributes and factors unrelated to the data attributes in response to the data attributes comprising the hint, wherein when the data attributes comprise the hint, the selected storage tier is capable of comprising a storage tier that is different from the storage tier that would be selected if the data attributes alone were considered to select the storage tier.

19. The method of claim 17, wherein the data set management command comprises a data transfer command to transfer the data set from first logical addresses to second logical addresses, and wherein the performing the data set management operation further comprises:
moving the data set at the first logical addresses to the selected storage tier if the first logical addresses are not currently located in the selected storage tier; and
after the first logical addresses are located in the selected storage tier, transferring the data set from the first logical addresses to the second logical addresses in the selected storage tier.

20. The method of claim 17, wherein the data set management command comprises a data reorganization command, and wherein the performing the data set management operation further comprises:
sending to the application data set attributes for the data set in response to receiving a request from the application prior to receiving the data set management operation and the data attributes from the application;
wherein the performing the data reorganization operation comprises:
moving the data set to the selected storage tier if the data set is not current located in the selected storage tier; and
reorganizing the data set in the selected storage tier to another location in the selected storage tier.
